(19) United States
(12) Patent Application Publication
(10) Pub. No.: US 2017/0193446 A1
(43) Pub. Date: Jul. 6, 2017

(54) Machine Maintenance Records (MMR)

(71) Applicants: Shawket B. Ayub, Plano, TX (US); Sabrina Akhtar, San Diego, CA (US)

(72) Inventors: Shawket B. Ayub, Plano, TX (US); Sabrina Akhtar, San Diego, CA (US)

(21) Appl. No.: 14/986,668

(22) Filed: Jan. 2, 2016

(51) Int. Cl. G06Q 10/10; G06F 19/00; G06Q 10/00

(52) U.S. Cl. CPC G06Q 10/10; G06Q 10/20; G06F 19/322

(57) ABSTRACT

The Machine Maintenance Records (MMR) system is a central electronic database that monitors assets from creation to failure. The asset tracking is done automatically and eliminates the need for any paper documents. All information about the asset can be fully accessed by the consumer, original equipment manufacturer (OEM),repair service providers, doctors and other service provider, using smart phone, tablet, computer or any other electronic media instantly.

The Smart Communication Protocol (SCP), which is a programmed code added to an Asset Distress Call (ADC) chip on the equipment to send distress calls or maintenance reminders via the ADC chip Wi-Fi before a catastrophic failure occurs.

### BACKGROUND

Consumers need to have easy access to the following on high value (automobile, mechanical equipment, etc.) electronically:
1) User manual.
2) Time sensitive preventive maintenance and reminders.
3) Manufacturer recall and updates.
4) Repair records and repair history.

Currently, consumers have no convenient means to access to these information when needed or means to store these valuable information for accessing later. Most of these records are either available on the manufacturer server, servicing center server, or on papers that were given to the consumer by manufacturers and the service providers during the purchase and during servicing the Assets.

This idea/invention creates a central electronic database for storing Asset information automatically and to create a web-based application to communicate with consumers' electronic devices such as smart phones, tablets, computers, etc., for further consumer input and output, The program will also have the built-in capability to notify the consumer of due maintenance or repair needed prior to equipment failure.

Consumers' Asset maintenance and repair records are important to prolong the life of an expensive Asset. Consumers need to have access to these records easily via electronic media when needed to read/review user manuals, recall documents, and schedule preventive repairs.

### BRIEF SUMMARY OF THE INVENTION

This Invention is to create and maintain a central database called Machine Maintenance Records (MMR.) which, tracks all records automatically after initial creation of the data file toy the manufacturer using the Asset's model and serial number on the MMR central database. This file can be accessed by the manufacturer, service providers, and consumer using any computing (Smart phone, Tablet, computer) or electronic platform from the MMR database.

The MMR system's additional feature is Smart Communication Protocol (SCP), which is a programmed code added to an Asset Distress Call (MC) chip on the equipment to send distress calls or maintenance reminders via the ADC chip Wi-Fi before a catastrophic failure occurs.

### DETAILED DESCRIPTION OF THE INVENTION

First, the Original Equipment Manufacturer (OEM) creates the data file by entering the Model and Serial number of the Asset/Equipment's. The printed documents that are normally included with the As set/Equipment are now entered into the electronic database, The maintenance timeline with reminders are also included. This creates the birth record and handling instruction of the Asset/Equipment into the MMR electronic Database located in MMR central server for the consumer.

When the asset/equipment is purchased by the consumer, these records and instructions are automatically transferred to the end user after registration with full access to the MMR database by the asset/equipment model and serial number.

The information in the MMR database is accessible by the OEM, service providers, end user, or any party authorized by the end user. Additionally, the OEM can post recalls, update patches, technical bulletins, or review repair records of the sold asset to assess warranty issues and design flaws for further improvements on next models; or to apply fixes to existing models.

The repair service provider can evaluate the Asset's history such as, repair records, and other services done such as schedule or non-schedule maintenance, repairs, and recalls from the MMR database to provide accurate service.

Any work done by the service provider for repair or maintenance gets updated in the central MMR database automatically by the model and serial number when the service provider writes the detail of the work done on the invoice document for payment using the MMR database invoice application.

Other critical information such as recall, patch, or service bulletin can be entered by the OEM even after the equipment is in service to the central MMR database for the consumer and service provider to use when needed.

The Asset's data are useful during the life of the product for the consumer for keeping track of the health of the equipment. Similarly, this information is very useful to the service provider and OEM during the life of the product for further data analysis on improvement and warranty.

Design Advantage:

Eliminates paper documents: The MMR system eliminates all paper documents that the OEM provides with the Asset/Equipment, such as the user manual, warranty documents, and service bulletins. The repair printed documents and invoices that service providers currently provide can also be eliminated, since these information will be entered automatically to the MMR database for consumer access. Currently, these Assets are managed on paper invoices and telephone only. There are no electronic data for the owner records. The maintenance and repair documents and invoice papers given to the Consumer for records keeping most of the time get lost or not available when needed. Few well organized consumers keep tracks of all paper trails or manually enter information in some form of data manning program.

Records and reminders are easily accessible: The consumer or service provider has easy access to the records when needed by connecting to the internet via smartphone, tablet, or a computer using the MMR application. The smart MMR application with an ADC (Asset Distress Call) chip sends reminders to consumers for scheduled maintenance service or repairs generated from the equipment's internal sensors. The data is communicated via consumer's Wi-Fi connected internet network or via Bluetooth Wireless (BTW) communication protocol connected to end user smartphone to the MMR central database to issue reminders.

Market on repair services: In addition to sending reminders for repair and maintenance, the smart MMR also automatically shops for the best priced service and notifies the end user. It can even set up a service schedule between the service facility and the end user at a competitive negotiated price once the end user approves to such search.

Tracking: The MMR central electronic Database application, with customize data entry form will eliminate paper trail. All information for specific equipment by Equipment Model, serial number, purchase date, user manual, preventative maintenance, repair records, recall records. Patch etc. will be available in the MMR database acquisition system. These data always remain in the database until the life of the Assets/Equipment and are transferable to new owner. Additionally, Service or maintenance center, consumer and original equipment manufacturer (OEM) will have access to the same database when needed. This eliminates any manual data entering and duplication and eliminates paper documents.

MMR System in Operation:

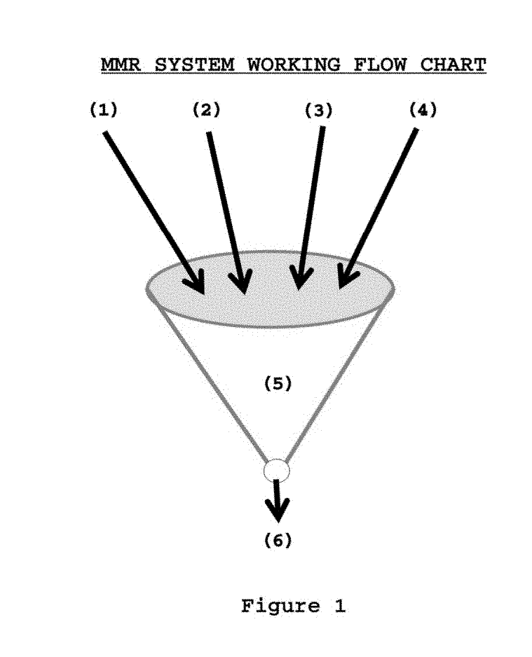

The MMR system is operated by the following method. (Refer to FIG. 1 of the MMR SYSTEM WORKING FLOW CHART DRAWING) Input (1), (2), (3), and (4) shown in FIG. 1 are listed below. MMR Central Server is denoted as (5). All the inputs are stored in (5).

FIG. 1 (1)
Every Asset/Equipment manufactured has unique Model and Serial number. OEM creates a file by Asset/Equipment Model and Serial number on the MMR central database (5), providing the necessary information (user manual, warranty records, etc.) and suggested maintenance timeline and reminders.

FIG. 1 (2)
At the time of purchase Consumer information's are also added to (5). Access is granted to MMR central database (5) during consumer registration or at the time of purchase.

FIG. 1 (3)
When the Asset/Equipment is taken for Service. The service provider generates billing invoice describing the work done on the service provider's computer using the MMR application. The service provider computer connects to the MMR central database (5) and saves the service work done. This record are permanent records in the MMR central database (5) for later reviewing when needed,

FIG. 1 (4)
Asset Distress Call (ADC) chip can send distress signals in the event of any equipment malfunction to MMR Central database (5) to notify equipment owner on the problem for further inquiry.

The output is denoted by FIG. 1 (6). This is where data are reviewed/accessed by the service providers, consumers and OEM on PC, Laptop, Tablet or Smartphone using MMR Application on the device, to review and analyze data for service, recall, warranty, design issues, upgrade, improvements, repair records and scheduling repairs,

Alternate Applications of MMR System
1. The MMR can generate consumer report using the service data and repair records.
2. Manufacturer can use data to improve design and track warranty and claims.
3. Service providers can analyze data to prepare work force for better training and purchase repair tools and parts in advance.
4. Service providers can advertise their service on the service call generated by the MMR application.
5. Consumer can collect the data on the product to allocate budget on the maintenance cost and repairs when purchasing the product.
6. MMR system and application can also be utilized for tracking personal health. Health records currently reside on the doctor's office server. Changing doctors or relocating can lose continuation of personal medical history. Transferring personal medical history has been a problem and user does not have records for easy access to these vital Medical records, especially during emergency. The MMR system can be applied to keep personal health records for the life of the person and are easily accessible at any time.
7. Human health bio-sensors that capture data into smartphones can send data to the MMR database central serves, which integrates the information for further actions and sends distress calls when needed.
8. MMR system and application can be utilize by insurance companies prior to selling insurance.
9. Transportation Fleet (Bus, Airplane, ship) management can use MMR system to track repairs and preventative maintenance.
10. MMR system can be useful on Defense equipment for schedule preventative maintenance. Tracks the damages and repairs. This keeps the equipment up-to-date for efficient operation and always ready.

1. Central Database of (MMR) system for storing and updating Consumer Assets (Automobile, Machinery, Utility, Bus, Airplanes and any other mostly Equipment) for maintenance and repairs and for analyzing data for servicing.
a. Manufacture use Assets data from the MMR Database to improve design, track warranty and claims.
b. Service Providers can analyze data to prepare work force for better training and purchase repair tools and parts for repair ready.
c. Service Provider can advertise their service based of the service call generated by the MMR application.
d. Can generate consumer report using the service data and repair record.
e. Consumer can collect the data on the product to allocate budget on the maintenance coat and repairs when purchasing the product.

2. Central Database of (MMR) system for storing patent health information for Doctor to access these records after patent approval or use smart card (MMR access card) in case of emergency. MMR central database of personal health can store individual medical history at one location, that can be easily accessed on various electronic platforms, instead of local database which is difficult to access and time consuming.
a. Personal medical records and history in the MMR system can used by doctor, hospital, insurance company and individual for reviewing health records for future assessment and preventative plan.
b. Human health bio-sensors that capture data into the Smartphones can send data to the MMR database central server, which simulate the information and records for further actions to send distress call if needed.
c. MMR systems and application can be used by insurance company prior selling insurance.

3. Transportation (Bus, car, ship & airplanes) and Defense equipment's user manual, technical documents, preventive maintenance and repair records can store in the central database of MMR system. User can assess the records for Fleet preventative maintenance records and repairs, which keep the equipment up-to-date for efficient operation and always ready.
